(19) United States
(12) Patent Application Publication
(10) Pub. No.: US 2024/0418102 A1
(43) Pub. Date: Dec. 19, 2024

(54) METHOD FOR DETERMINING A FUEL CONSUMPTION MARGIN OF AN ENGINE IN RELATION TO A THEORETICAL CONSUMPTION

(71) Applicant: AIRBUS HELICOPTERS, Marignane Cedex (FR)

(72) Inventors: Claire LECAUCHOIS, Aix En Provence (FR); Florent ESTERLE, Salon De Provence (FR)

(73) Assignee: AIRBUS HELICOPTERS, Marignane Cedex (FR)

(21) Appl. No.: 18/442,422

(22) Filed: Feb. 15, 2024

(30) Foreign Application Priority Data
Jun. 15, 2023 (FR) 2306124

(51) Int. Cl. F01D 21/00; G01M 15/14

(52) U.S. Cl. CPC F01D 21/003; G01M 15/14; F05D 2260/83

(57) ABSTRACT

A method for determining a current fuel consumption margin of a functional engine of an aircraft in relation to a theoretical fuel consumption of a reference engine. This method comprises: a) when in flight, performing at least one engine health check comprising at least measuring a current value of a monitoring temperature and a control value of a power parameter of said functional engine; b) determining, as a function at least of the control value, with a consumption model applied by a controller, said current fuel consumption margin in relation to the theoretical fuel consumption; and c) transmitting said current fuel consumption margin to a receiver.

### CROSS-REFERENCE TO RELATED APPLICATIONS

This application claims priority to French patent application No. FR 23 06124 filed on Jun. 15, 2023, the disclosure of which is incorporated in its entirety by reference herein.

### TECHNICAL FIELD

The present disclosure relates to a method for determining a fuel consumption margin of an engine in relation to a theoretical consumption.

### BACKGROUND

Hereinafter, the term “consumption” denotes a flow rate of fuel, such as a volume flow rate expressed, for example, in liters per second or a mass flow rate expressed, for example, in kilograms per second.

The disclosure therefore lies in the technical field of power plants of vehicles, in particular of an aircraft and more particularly of a rotorcraft.

Indeed, an aircraft is conventionally provided with a power plant. For example, a rotary-wing aircraft comprises a power plant provided with at least one engine for rotating a rotary wing. A helicopter is often equipped with at least one turboshaft engine, that may be referred to as a “gas turbine”.

Furthermore, the dimensions of each engine are such that it can be used at at least one operating rating, each operating rating associating an amount of power produced with a duration of use. Known ratings include the following:
take-off rating, that associates a maximum take-off power MTOP with a duration of use of approximately five to ten minutes; and
maximum continuous rating, that associates a maximum continuous power MCP with an unlimited duration of use.

Multi-engine aircraft also have contingency overpower ratings, these ratings being used when one of the engines fails. These overpower ratings may comprise:
a first contingency rating, that associates a super-contingency power OEI30″ with a duration of use of approximately thirty seconds, that can be used two or three times;
a second contingency rating, that associates a maximum contingency power OEI2′ with a cumulative duration of use of approximately two minutes; and
a third contingency rating, that associates an intermediate contingency power OEIcont with a duration of use covering the end of a flight, for example.

At the same time, it is common practice to determine the number of flight hours an aircraft engine can withstand before needing to be overhauled. This number of flight hours is known by the acronym TBO, that stands for “time between overhauls”.

In these conditions, a guaranteed minimum power is established for each rating. This guaranteed minimum power corresponds to the minimum power that the engine will be able to deliver when it has reached said number of flight hours TBO, such an engine being referred to hereinafter as an “aged engine” for the sake of convenience.

The performance of an aircraft depends on the power that can be produced by each engine. However, the power produced by an engine tends to decrease over time. Therefore, in order to guarantee the required performances regardless of the age of an aircraft's engines, an aircraft's performances can be calculated on the basis of the guaranteed minimum powers, whereas the aircraft's performances may be assessed upwards in the presence of new engines.

One of these performances is an engine's theoretical fuel consumption, that is determined in particular on the basis of the consumption of a generic reference engine with a given level of ageing. For example, such a reference engine may correspond to a new engine capable of supplying a guaranteed minimum power referred to as “mini new” or to an aged engine capable of supplying a guaranteed minimum power referred to as “mini aged”. An aircraft's flight manual may thus provide a model giving the theoretical fuel consumption of the engine or engines as a function of the applied rating, this theoretical fuel consumption being equal to the consumption of the reference engine. Using this theoretical consumption, a pilot can then assess the quantity of fuel to be taken on board in order to complete a mission, or can assess the range with a given quantity of fuel and the weight on board.

As this method is advantageously conservative, the theoretical fuel consumption is generally greater than the actual fuel consumption of a given engine. Indeed, a new engine tends to consume less fuel than an aged engine. Therefore, taking into account not actual but theoretical fuel consumption when drawing up a flight plan, may tend, for example, to overestimate the volume of fuel to be taken on board. The excess fuel can limit the weight of the payload that can be carried.

Moreover, some certification regulations may require means for verifying that each engine is able to supply the guaranteed minimum powers enabling the aircraft to achieve the certified performances.

In order to verify that an engine is operating correctly, an engine health check is performed to ensure that this engine produces power greater than or equal to the guaranteed minimum power of a given rating. If this is the case, the engine remains capable of supplying the powers required to achieve the certified performances. If not, unplanned maintenance action needs to be undertaken.

For example, the health check may consist in measuring the current value of a monitoring parameter, then verifying that the value of the current power produced by the engine is greater than or equal to the value of the guaranteed minimum power that an aged engine would have in the same conditions, i.e., at the iso-value of the monitoring parameter.

The monitoring parameter may be a temperature of the engine, this temperature being able to be the temperature TET of the gases at the inlet of a high-pressure turbine of a gas generator or the temperature T45 of the gases at the inlet of a free turbine of a turboshaft engine.

The guaranteed minimum powers are conventionally established by testing an engine on a test bench. In order to compare the results of measurements taken during flight with measurements taken on a test bench, the measurement conditions during flight may be optimized in order to be close to the measurement conditions on a test bench. The measurements taken on a test bench are taken in thermally stable conditions. Therefore, in order to perform an engine health check during flight, the aircraft may be placed in a particular flight phase such as level flight at stabilized altitude and speed for several minutes. The pilot may then initiate a manual action requiring an engine health check to be performed or indeed such an engine health check may be performed automatically when the required conditions are present.

Furthermore, in order to assess the current power produced by an engine, installation effects may be taken into consideration. Installation effects result in increased fuel consumption and power losses due, for example, to pressure losses in engine air inlets or indeed to pressure distortions. Installation effects also include power losses due to power being drawn from the engine by accessories and/or due to the altitude of the aircraft and/or due to the outside temperature, in particular.

These installation effects tend to reduce the power produced by an output shaft of an engine once installed on an aircraft. Installation effects are therefore also referred to as “installation losses” in reference to the loss of power that occurs. Therefore, a loss of power corresponding to the installation losses may be assessed in order to determine the current power of the engine as such. The current power of the engine may thus be equal to the sum of the loss of power and the power measured during flight produced by an output shaft of the engine installed on an aircraft.

Documents EP 2 623 747 B1, EP 2 623 748 B1 and EP 3 730 410 B1 disclose engine health checks.

Document EP 3 123 254 B1 is known but is far removed from the problem of determining the actual fuel consumption of an engine.

Documents EP 1 103 926 A2, RU 2 627 742 C2 and US 2018/119628 A1 are also known. Document EP 1 103 926 A2 is in particular far removed from the problem of the disclosure, as it relates to a system for determining the presence of an engine failure. Documents RU 2 627 742 C2 and US 2018/119628 A1 are also far removed from the disclosure.

### SUMMARY

An object of the present disclosure is thus to propose a method for determining a fuel consumption margin of an engine in relation to a theoretical fuel consumption, in particular in order to optimize the aircraft's range or the payload that it can carry.

The disclosure therefore relates to a method for determining a current fuel consumption margin of a functional engine of an aircraft in relation to a theoretical fuel consumption of a reference engine.

This method comprises an assessment phase comprising the following steps:
when in flight, during at least one flight for parameterizing the aircraft, performing at least one engine health check comprising at least: i) measuring, with a temperature sensor, a current value of a monitoring temperature of the functional engine; and ii) determining, with a power sensor, a control value of a power parameter of said functional engine;
determining, as a function at least of the control value for a given current value of the monitoring temperature of the functional engine, with a consumption model applied by a controller, said current fuel consumption margin in relation to the theoretical fuel consumption, the theoretical fuel consumption being a fuel consumption of the reference engine determined as a function of said control value; and
transmitting said current fuel consumption margin to a receiver.

The expression “functional engine” denotes an engine of the aircraft. The term “functional” is used to identify this engine and to avoid confusing it with other engines.

The expression “reference engine” denotes an engine of the same model as the functional engine, i.e., an engine identical to the functional engine. However, the reference model may have a service life that is substantially, or indeed strictly, equal to the service life that should lead to an overhaul, conventionally referred to as TBO.

The controller is a device installed in the aircraft or remotely outside the aircraft for determining the current fuel consumption margin of an aircraft in relation to the theoretical fuel consumption of the reference engine.

According to this method, the controller receives the current value of a temperature of the functional engine at a predetermined location of this engine, this temperature being referred to as the “monitoring temperature”. The controller also receives the control value of a power parameter of the functional engine. This power parameter may be a mechanical power, this mechanical power possibly being equal to the power produced by the engine, possibly corrected by adding a predetermined or calculated power corresponding to installation effects. The controller deduces from this the fuel consumption margin of the functional engine compared with the reference engine for operation at iso-power margin at the monitoring temperature.

Indeed, the monitoring temperature has a direct impact on the fuel consumption of the engine, in particular for a turboshaft engine. In order to compare the operation of the functional engine and the reference engine, the controller compares the operation of this functional engine and of this reference engine in the presence of the same monitoring temperature.

Furthermore, the fuel consumption of an engine and the power produced by this engine vary in a similar manner, in particular for a turboshaft engine. Therefore, a consumption model may be established. This consumption model can be used to obtain the fuel consumption margin of the functional engine compared with the reference engine. For example, a new engine may have a fuel consumption margin of approximately 2% to 6% of the theoretical fuel consumption measured on the reference engine.

A controller may thus, for example, use one or more engine health checks performed previously in order to assess the current fuel consumption margin of the functional engine. This controller then issues a command signal carrying this current fuel consumption margin to a receiver. For example, such a receiver comprises a display displaying the consumption margin after receiving the command signal. A pilot can then take this consumption margin into consideration in order to optimize the fuel taken on board and/or the weight of the payload on board.

If there are several functional engines on an aircraft, the method may be applied to each functional engine, for example. The total fuel consumption of the installation then corresponds to the sum of the individual fuel consumptions of the functional engines. The method may also comprise one or more of the following features.

According to one possibility, the functional engine and the reference engine may be identical turboshaft engines, i.e., identical models, each comprising a gas generator and at least one free turbine. The monitoring temperature may then be a temperature of gas at the inlet of a high-pressure turbine of the gas generator of the associated engine or a temperature of the gases at the inlet of the free turbine of the associated engine.

According to one possibility compatible with the preceding possibilities, the power parameter may be a mechanical power, and determining, as a function at least the control value, of a current fuel consumption margin, comprising determining an intermediate power margin between the control value and a guaranteed minimum power obtained with the reference engine having said monitoring temperature equal to the current value.

The power margin of an engine at iso-monitoring temperature is correlated with fuel consumption. Using the power margin at iso-monitoring temperature helps obtain a method for accurately assessing a fuel consumption margin. Indeed, the power produced by an engine may be determined accurately, and indeed more accurately than measuring a flow rate of fuel with the flowmeters installed on the aircraft, for example.

Furthermore, such a guaranteed minimum power may advantageously take into account the installation effects reducing the power produced by an output shaft of an engine once installed on an aircraft.

Determining, as a function at least of the control value, a current fuel consumption margin, may then comprise: i) determining a reference power margin equal to the intermediate power margin or to a mean of several intermediate power margins assessed during several engine health checks; and ii) converting the reference power margin into the current fuel consumption margin by means of the controller, using said consumption model.

Said mean may, for example, be an arithmetic mean taking into consideration the n preceding engine health checks, n being a predetermined positive integer.

Depending on the degree of accuracy sought, only the most recent engine health check or several health checks are used to assess the current power margin in relation to the reference engine, and consequently the current fuel consumption margin.

Said consumption model may possibly provide said current fuel consumption margin as a function of said reference power margin.

According to one possibility compatible with the preceding possibilities, the method may comprise an initialization phase that comprises determining said consumption model.

The initialization phase can be used to determine the consumption model used by the controller to convert a power margin into a fuel consumption margin.

According to a first alternative, determining said consumption model may comprise:
a plurality of tests carried out on at least one test engine arranged on a test bench, each test including determining a power produced by the test engine at a test point and a flow rate of fuel consumed by the test engine at the test point and a test value of the monitoring temperature at the test point;
for each test, determining a parameterization power margin and a parameterization fuel consumption margin respectively in relation to a guaranteed minimum power at the test value of the monitoring temperature and a theoretical fuel consumption obtained with the reference engine in the presence of the power produced by the test engine; and
determining the consumption model as a function of the parameterization power margin and the parameterization fuel consumption margin of each test.

According to the first alternative, each test point can be used to determine the fuel consumption margin of the test engine, referred to as the “parameterization fuel consumption margin”, as a function of the power margin of the test engine, referred to as the “parameterization power margin”. Measuring a flow rate of fuel on the test bench is effectively reliable. Using the point cloud that is obtained, a computer, for example the controller, can use a known method to determine a law giving a fuel consumption margin as a function of the power margin. For example, a linear regression method can be used to determine an affine function giving a fuel consumption margin as a function of a power margin. The consumption model is then in the form of this affine function.

According to a second alternative, determining the consumption model may comprise:
a plurality of tests carried out on at least one test engine in flight, each test including determining a power produced by the test engine at a test point and a flow rate of fuel consumed by the test engine at the test point and a test value of the monitoring temperature at the test point;
for each test, determining a corrected flow rate of fuel as a function of the flow rate of fuel consumed by the test engine at the test point and a correction model;
for each test, determining a parameterization power margin and a parameterization fuel consumption margin respectively in relation to a guaranteed minimum power at the test value of the monitoring temperature and a theoretical fuel consumption obtained with the reference engine in the presence of the test value for the power produced by the test engine; and
determining the consumption model as a function of the parameterization power margin and the parameterization fuel consumption margin of each test.

According to the second alternative, the tests are carried out in flight, not on the test bench. The flow rate of fuel measured in flight is then corrected by means of a correction model. This correction model may be established, for example, by using a method of linear or polynomial regression obtained from accurate fuel consumptions measured on the test bench with dedicated flowmeters and, simultaneously, with a management system on board the aircraft and generally referred to as a FADEC, standing for “Full Authority Digital Engine Control”. Such a correction model therefore makes it possible to characterize the estimation error of the FADEC in relation to the calibrated flowmeters on the test bench and can then be used in flight in order to improve the accuracy of the fuel flow rate measurements provided by the FADEC.

According to another aspect, the disclosure also relates to a method for filling an aircraft with fuel to reach a destination, said method comprising preparing a route comprising at least one flight segment.

This method for filling an aircraft with fuel to reach a destination comprises the following steps:
for at least said segment of the flight plan, determining a current fuel consumption margin by applying the method described above for determining a fuel consumption margin of an engine in relation to a theoretical fuel consumption, said at least one engine health check being performed during a flight preceding said preparation of a route comprising at least one flight segment;
determining a theoretical fuel consumption during said flight segment based on the theoretical model established with said reference engine;
determining a predicted fuel consumption comprising applying the current fuel consumption margin to the theoretical fuel consumption;
determining a required quantity of fuel, i.e., a required volume of fuel or a required weight of fuel, as a function of the predicted fuel consumption; and
transmitting the required quantity of fuel.

The method may then comprise a step of filling the aircraft with fuel, said required quantity of fuel being loaded into the aircraft before the start of the mission.

The expression “required quantity of fuel” denotes a sufficient quantity of fuel to complete the planned flight.

This method can therefore be used to determine the quantity of fuel that is sufficient to follow a route, for example in order to optimize the aircraft's payload.

The disclosure also relates to an aircraft provided with at least one functional engine. This aircraft comprises a planning system configured to apply the abovementioned method for determining a current fuel consumption margin, said planning system comprising said controller and said power sensor and said temperature sensor, said planning system having a receiver receiving said current fuel consumption margin determined by said controller.

### BRIEF DESCRIPTION OF THE DRAWINGS

The disclosure and its advantages appear in greater detail in the context of the following description of embodiments given by way of illustration and with reference to the accompanying figures, wherein:

FIG. 1 is a view of an aircraft configured to apply the method for determining a current fuel consumption margin;

FIG. 2 is a diagram showing the method for determining a current fuel consumption margin;

FIG. 3 is a diagram showing a consumption model; and

FIG. 4 is a diagram showing a method for filling an aircraft with fuel according to the disclosure.

### DETAILED DESCRIPTION

Elements that are present in more than one of the figures are given the same references in each of them.

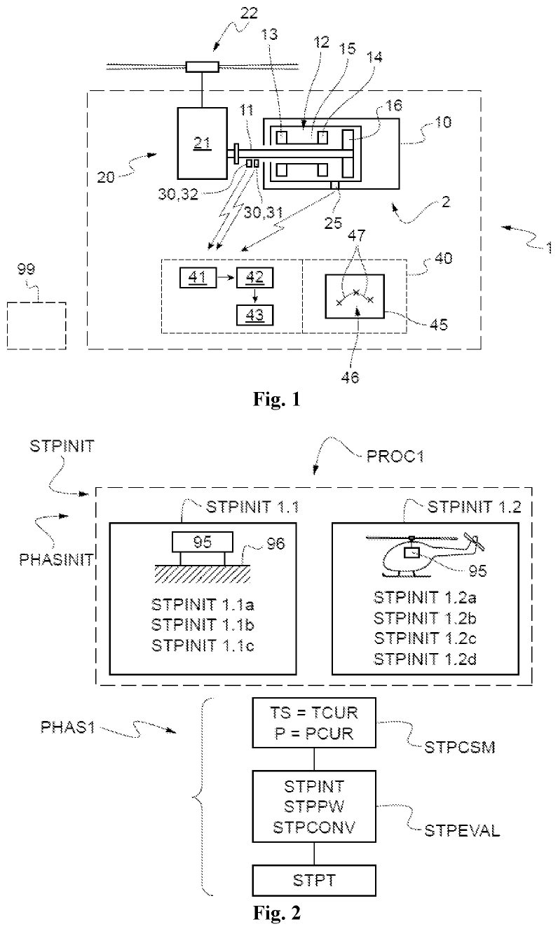

FIG. 1 shows an aircraft 1 according to the disclosure. Such an aircraft 1 is provided with a power plant 2 comprising at least one functional engine 10. The functional engine or engines 10 each comprise a working shaft 11 connected to a power train 20. For example, this power train 20 comprises a rotor 22 contributing at least to the lift and/or to the propulsion or traction of the aircraft 1. According to the example shown, at least one functional engine 10 comprises a shaft connected by a mechanical link to a gearbox 21, this gearbox 21 being connected by another mechanical link to a rotor 22.

According to another aspect, the functional engine or engines 10 may be turboshaft engines. Such a turboshaft engine then comprises a gas generator 12 provided with a compressor 13 comprising one or more compression stages, a combustion chamber 15 and at least one high-pressure turbine 14. The high-pressure turbine or turbines 14 are connected to the compressor 13 by an inner shaft. After the gas generator 12, in the direction of flow of the gases in the functional engine 10, the functional engine 10 comprises a free assembly provided with at least one free turbine 16 secured to the working shaft 11.

Moreover, the aircraft's performances are established based on the performances of a reference engine 99 that is not installed on the aircraft 1. The functional engine 10 and the reference engine 99 have different performances and, in particular, have fuel flow rates that differ due to their respective durations of use. At the same power level and under the same conditions, the flow rate of fuel supplying the reference engine 99 is greater than or equal to the flow rate of fuel supplying the functional engine 10, that is potentially less used.

This aircraft 1 cooperates with a planning system 40 configured in particular to determine the actual fuel consumption of the functional engine 10 before a flight, this fuel consumption being referred to for convenience as the “current fuel consumption DQ” and representing the flow rate of fuel supplied to the functional engine 10.

This planning system 40 comprises a temperature sensor 25 configured to measure a temperature in the functional engine 10, a power sensor configured to assess a power produced by the functional engine 10, and a controller 42 configured to determine the current fuel consumption by taking the measured temperature and the measured power into consideration.

The term “sensor” denotes a sensing device capable of directly measuring the parameter in question but also a system that may comprise one or more sensing devices as well as means for processing the signal that make it possible to provide an estimation of the parameter in question based on the measurements provided by this or these physical sensing devices.

FIG. 1 shows an example of the architecture of an aircraft in order to illustrate the disclosure. Other known aircraft architectures may naturally be used without going beyond the ambit of the disclosure.

Therefore, the temperature sensor 25 may be a standard sensor arranged inside the functional engine 10. The temperature sensor 25 emits a signal carrying a monitoring temperature TS inside the functional engine 10.

The term “signal” is used in the description to denote a digital, analog, optical or electrical signal, for example.

The temperature sensor 25 may be positioned in such a way as to measure a monitoring temperature of the “turbine entry temperature TET” type, being arranged at the inlet of the free assembly, or of the “temperature T45” type, being arranged at the inlet of a high-pressure turbine 14.

Furthermore, the power sensor 30 may be a standard sensor configured to measure a power that is a reflection of the power produced by the functional engine 10. For example, the power sensor 30 comprises a speed sensing device 31 and a torquemeter 32 arranged on a measuring shaft set in motion by the low-pressure turbine or turbines 16. For example, the measuring shaft may be the working shaft 11. The speed sensing device 31 emits a speed signal carrying a speed of rotation of the measuring shaft, and the torquemeter 32 emits a torque signal carrying the torque applied to the measuring shaft. A standard computer can then determine the produced power by multiplying the measured speed of rotation and torque, and even a proportionality coefficient, and possibly by correcting this product with calculated or fixed installation losses.

The planning system 40 may possibly comprise a memory storing the signals emitted by the power sensor 30 and the temperature sensor 25, or the values of the temperatures and powers measured or decoded by a standard computer.

The controller 42 may be arranged in the aircraft 1 according to the example shown, or may be remote from the aircraft 1. The controller 42 can receive the signal emitted by the temperature sensor 25 and the signal or signals emitted by the power sensor 30 in order to receive and decode them and deduce therefrom the measured monitoring temperature and power. Alternatively, the controller 42 may be connected to the memory 41, this memory 41 storing the measured monitoring temperature and power.

The controller 42 may have one or more processing units comprising, for example, at least one processor and at least one memory, at least one integrated circuit, at least one programmable system, at least one logic circuit, these examples not limiting the scope given to the expression “processing unit”. The term “processor” may refer equally to a central processing unit or CPU, a graphics processing unit or GPU, a digital signal processor or DSP, a microcontroller, etc.

The controller 42 may be connected via a wired or wireless link to a receiver 43. This receiver 43 may, for example, be in the form of a display. The receiver 43 may be arranged inside or outside the aircraft 1.

The controller 42 may be connected via a wired or wireless link to a planner 45. The planner 45 may be arranged inside or outside the aircraft 1. This planner 45 may, for example, comprise a display and a human-machine interface for parameterizing data in order to establish a route 46. Such a route 46 may comprise at least one flight segment 47 between two waypoints. For example, the data that can be parameterized comprise a point of destination to be reached with the aircraft 1, a point of origin of the flight, one or more intermediate waypoints, etc.

Moreover, the aircraft 1 and the planning system 40 are configured to apply the method PROC1 for determining a current fuel consumption margin DQ of the aircraft 1 shown in FIG. 2.

This method PROC1 for determining a current fuel consumption margin DQ may comprise an initialization phase PHASINI. This initialization phase PHASINI comprises determining STPINI a consumption model.

According to a first alternative, the determination STPINI of a consumption model comprises a plurality of tests STPINI1.1 carried out on at least one test engine 95 arranged on a test bench 96. Each test includes determining STPINI1.1a:
a power PINI produced by the test engine 95 at a test point, i.e., at a measurement instant, by using a power sensor of the type described above;
a flow rate of fuel QINI consumed by the test engine 95 at the test point, by using a standard flowmeter; and
and a test value TINI of the monitoring temperature TS at the test point, by using a temperature sensor of the type described above.

For each test that is carried out, the determination STPINI of said consumption model comprises determining STPINI1.1b, with a processing unit referred to for convenience as a “modelling computer”, a parameterization power DPINI a margin and parameterization fuel consumption margin DOINI respectively in relation to a guaranteed minimum power PMINI for the same test value TINI and a theoretical fuel consumption Qref obtained with the reference engine 99 in the presence of the test value TINI for the power measured at the monitoring temperature TS.

By way of illustration, the test value is relative to the temperature T45 and is equal to 900 degrees Celsius, and the flow rate of fuel QINI consumed is equal to 200 liters per hour and the power PINI is equal to 600 kilowatts. The modelling computer can store a chart or the like providing the guaranteed minimum power PMINI and the theoretical fuel consumption Qref as a function, respectively, of the monitoring temperature TS and the measured power, this data being established during tests on a reference engine 99. For example, for a temperature T45 of 900 degrees Celsius, the power Pmini is equal to 500 kilowatts, and for a power PINI of 600 kW, the flow rate of fuel Qref is equal to 210 liters per hour. Therefore, the parameterization power margin DPINI is equal to 600-500, i.e., 100 kilowatts, and the parameterization fuel consumption margin DQINI is then 10 liters per hour, or can be expressed as a percentage of the flow rate of fuel Qref, i.e., 4.76%.

Therefore, the determination STPINI of said consumption model comprises determining STPINI1.1c the consumption model as a function of the parameterization power margin DPINI and the parameterization fuel consumption margin DQINI of each test.

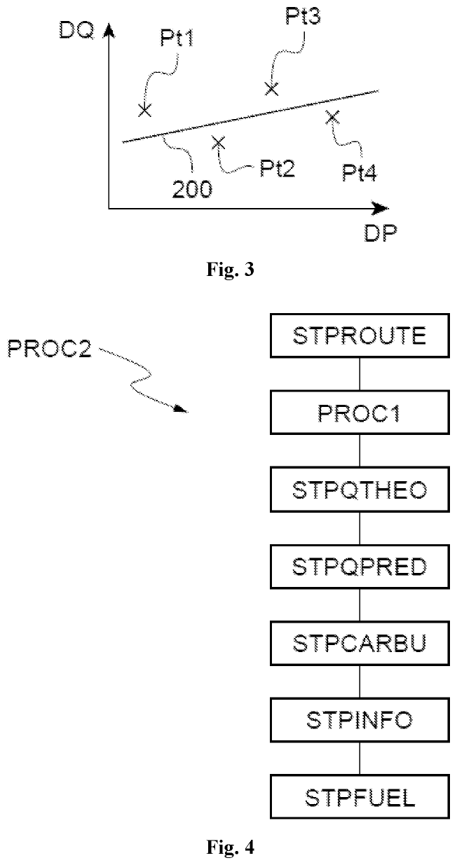

According to FIG. 3, each test point can be plotted in a diagram comprising a power margin DP on the X-axis and a fuel consumption margin DQ on the Y-axis. In the example shown, four tests are carried out. Consequently, four points Pt1-Pt4 are arranged in the diagram, each point having the parameterization power margin DPINI and the parameterization fuel consumption margin DQINI determined during a test as coordinates. The modelling computer can then, for example, establish the equation of a line 200 in a conventional manner, typically by linear regression, this equation forming the consumption model.

According to a second alternative, the determination STPINI of the consumption model comprises a plurality of tests STPINI1.2 carried out in flight on at least one test engine 95 arranged on an aircraft. Each test includes determining STPINI1.2a:
a power PINI produced by the test engine 95 at a test point, i.e., at a measurement instant, by using a power sensor of the type described above;
a flow rate of fuel QINI consumed by the test engine 95 at the test point, by using a standard flowmeter; and
a test value TINI of the monitoring temperature TS at the test point, by using a temperature sensor of the type described above.

Moreover, a processing unit referred to for convenience as a “modelling computer” determines STP1.2b a corrected flow rate of fuel QCOR as a function of the flow rate of fuel QINI consumed by the test engine 95 at the test point and a correction model. The correction model may be established by tests or simulation to adjust the flow rate of fuel measured by the flowmeter of the aircraft in relation to a more accurate flowmeter.

For each test that is carried out, the determination STPINI of said consumption model comprises determining STPINI1.2c, with a modelling computer, for example, a parameterization power margin DPINI in relation to a guaranteed minimum power PMINI, and a parameterization fuel consumption margin DQINI between the corrected flow rate of fuel QCOR and the theoretical fuel consumption Qref.

Therefore, the determination STPINI of said consumption model comprises determining STPINI1.2d the consumption model as a function of the parameterization power margin DPINI and the parameterization fuel consumption margin DQINI of each test. This step may be identical to the corresponding step of the first alternative.

Irrespective of how the consumption model is established, the method PROC1 for determining a current fuel consumption margin DQ comprises an assessment phase PHAS1.

The assessment phase PHAS1 comprises performing STPCSM at least one engine health check in flight, i.e., when the aircraft 1 is not resting on a landing area. This engine health check is performed, for example in a conventional manner, at iso-monitoring temperature TS. The engine health check may be performed automatically or on command by operating a human-machine interface.

The engine health check or checks then comprise at least: i) measuring, with the temperature sensor 25, a current value TCUR of the monitoring temperature TS of the functional engine 10; and ii) determining, with the power sensor 30, a control value PCUR of a power parameter P of the functional engine 10.

Before a flight, the assessment phase comprises determining STPEVAL, as a function at least of the control value PCUR, with the consumption model applied by the controller 42, the current fuel consumption margin DO of the functional engine 10 in relation to its theoretical fuel consumption Qref, i.e., in relation to the fuel consumption of the reference engine 99 at iso-power at the monitoring temperature TS.

For example, during a step STPINT, the controller 42 determines an intermediate power margin DPINT between the control value PCUR and the guaranteed minimum power PMINI obtained with the reference engine 99 at iso-monitoring temperature TS.

During a step STPPW, the controller 42 can determine a reference power margin DPREF, that is equal, depending on the variant, to the intermediate power margin DPINT or to a mean of several intermediate power margins DPINT assessed during several preceding engine health checks CSM. During a step STPCONV, the controller 42 then converts the reference power margin DPREF into a current fuel consumption margin DQ with said consumption model. According to the example of FIG. 3, the reference power margin DPREF is injected for this purpose into the equation of the straight line determined during the initialization phase.

Finally, during a transmission step STPT, the controller 42 transmits a signal carrying the current fuel consumption margin DQ to the receiver 43. This receiver 43 can then, for example, display the current fuel consumption margin. A pilot can then adapt the fuel to be taken on board the aircraft 1 as a function of this margin.

FIG. 4 therefore shows a method PROC2 for filling the aircraft 1 with fuel to reach a destination.

This method comprises preparing STPROUTE a route 46 comprising at least one flight segment 47, for example with the planner 45.

For at least one segment 47 of the flight plan, the controller 42 then determines the current fuel consumption margin DQ of the functional engine or engines 10 of the aircraft 1 by applying the method PROC1 for determining a current fuel consumption margin, using the data estimated during at least one engine health check CSM performed during a preceding flight.

During a step STPQTHEO, the controller 42 or the planner 45 determines a theoretical fuel consumption Qref for this same flight segment 47 based on a stored theoretical model of the reference engine 99.

During a step STPQPRED, the controller 42 or the planner 45 determines a predicted fuel consumption QPRED by applying the current fuel consumption margin DQ to the theoretical fuel consumption Qref. By way of illustration, the theoretical fuel consumption Qref is 150 liters per hour and the determined current fuel consumption margin is 3% of this theoretical fuel consumption Qref. Therefore, the predicted fuel consumption QPRED is 150 divided by 1.03, i.e., 146.7 liters per hour.

Then, during a step STPCARBU, the controller 42 or the planner 45 determines a required volume of fuel or a required weight of fuel as a function of the predicted fuel consumption in order to reach the destination.

The controller 42 or the planner 45 transmits the required volume of fuel or the required weight of fuel, for example to the receiver 43 or to another display.

Therefore, the method may comprise transmitting STPINFO the required quantity of fuel to the receiver 43, then filling STPFUEL the aircraft 1, i.e., at least one tank, by storing the required volume of fuel or the required weight of fuel in the aircraft 1.

Naturally, the present disclosure is subject to numerous variations as regards its implementation. Although several embodiments are described above, it should readily be understood that it is not conceivable to identify exhaustively all the possible embodiments. It is naturally possible to envisage replacing any of the means described by equivalent means without going beyond the ambit of the present disclosure.

What is claimed is:

1. A method for determining a current fuel consumption margin of a functional engine of an aircraft in relation to a theoretical fuel consumption of a reference engine,
wherein the method comprises an assessment phase comprising the following steps:
when in flight, during at least one flight for parameterizing the aircraft, performing at least one engine health check comprising at least: measuring, with a temperature sensor, a current value of a monitoring temperature of the functional engine; and determining, with a power sensor, a control value of a power parameter of the functional engine;
determining, as a function at least of the control value for a given current value of the monitoring temperature of the functional engine, and with a consumption model applied by a controller, the current fuel consumption margin in relation to the theoretical fuel consumption, the theoretical fuel consumption being a fuel consumption of the reference engine determined as a function of the control value; and
transmitting the current fuel consumption margin to a receiver.

2. The method according to claim 1,
wherein, the functional engine and the reference engine being identical turboshaft engines each comprising a gas generator and at least one free turbine, the monitoring temperature is a temperature of gas at the inlet of a high-pressure turbine of the gas generator of the associated engine or a temperature of the gases at the inlet of the free turbine of the associated engine.

3. The method according to claim 1,
wherein the power parameter is a mechanical power, determining, as a function at least of the control value, the current fuel consumption margin, comprising determining an intermediate power margin between the control value and a guaranteed minimum power obtained with the reference engine having the monitoring temperature equal to the current value.

4. The method according to claim 3,
wherein determining, as a function at least of the control value, a current fuel consumption margin, comprises: i) determining a reference power margin equal to the intermediate power margin or to a mean of several intermediate power margins assessed during several engine health checks; and ii) converting the reference power margin into the current fuel consumption margin by means of the controller, using the consumption model.

5. The method according to claim 4,
wherein the consumption model provides the current fuel consumption margin as a function of the reference power margin.

6. The method according to claim 1,
wherein the method comprises an initialization phase that comprises determining the consumption model.

7. The method according to claim 6,
wherein determining the consumption model comprises:
a plurality of tests carried out on at least one test engine arranged on a test bench, each test including determining a power produced by the test engine at a test point and a flow rate of fuel consumed by the test engine at the test point and a test value of the monitoring temperature at the test point;
for each test, determining a parameterization power margin and a parameterization fuel consumption margin respectively in relation to a guaranteed minimum power at the test value of the monitoring temperature and a theoretical fuel consumption obtained with the reference engine in the presence of the power produced by the test engine; and
determining the consumption model as a function of the parameterization power margin and the parameterization fuel consumption margin of each test.

8. The method according to claim 6,
wherein determining the consumption model comprises:
a plurality of tests carried out on at least one test engine in flight, each test including determining a power produced by the test engine at a test point and a flow rate of fuel consumed by the test engine at the test point and a test value of the monitoring temperature at the test point;
for each test, determining a corrected flow rate of fuel as a function of the flow rate of fuel consumed by the test engine at the test point and a correction model;
for each test, determining a parameterization power margin and a parameterization fuel consumption margin respectively in relation to a guaranteed minimum power at the test value of the monitoring temperature and a theoretical fuel consumption obtained with the reference engine in the presence of the power produced by the test engine; and
determining the consumption model as a function of the parameterization power margin and the parameterization fuel consumption margin of each test.

9. A method for filling an aircraft with fuel to reach a destination, the method comprising preparing a route comprising at least one flight segment,
wherein the method for filling an aircraft with fuel to reach a destination comprises the following steps:
for at least the segment of the flight plan, determining a current fuel consumption margin by applying the method according to claim 1, the at least one engine health check being performed during a flight preceding the preparation of a route comprising at least one flight segment;
determining a theoretical fuel consumption during the flight segment based on a theoretical model established with the reference engine;
determining a predicted fuel consumption comprising applying the current fuel consumption margin to the theoretical fuel consumption;
determining a required quantity of fuel as a function of the predicted fuel consumption; and
transmitting the required quantity of fuel.

10. An aircraft equipped with at least one functional engine,
wherein the aircraft comprises a planning system configured to apply the method for determining a current fuel consumption margin according to claim 1, the planning system comprising the controller and the power sensor and the temperature sensor, the planning system having a receiver receiving the current fuel consumption margin determined by the controller.
